(19) United States
(12) Patent Application Publication
(10) Pub. No.: US 2014/0008584 A1
(43) Pub. Date: Jan. 9, 2014

(54) FLUORINATED POLYAMIDEIMIDE INTERMEDIATE TRANSFER MEMBERS

(71) Applicants: Jin Wu, Pittsford, NY (US); Jonathan H. Herko, Walworth, NY (US); Lin Ma, Pittsford, NY (US); Lanhui Zhang, Webster, NY (US)

(72) Inventors: Jin Wu, Pittsford, NY (US); Jonathan H. Herko, Walworth, NY (US); Lin Ma, Pittsford, NY (US); Lanhui Zhang, Webster, NY (US)

(73) Assignee: XEROX CORPORATION, Norwalk, CT (US)

(21) Appl. No.: 13/543,850

(22) Filed: Jul. 8, 2012

(51) Int. Cl. H01B 1/20; C08G 73/14; H01B 1/24

(52) U.S. Cl. 252/511; 252/500; 252/519.33; 528/70

(57) ABSTRACT

An intermediate transfer member that includes a fluorinated polyamideimide polymer, and an optional conductive component.

This disclosure is generally directed to an intermediate transfer member that includes a fluorinated polyamideimide and an intermediate transfer member that contains a mixture of a fluorinated polyamideimide, an optional conductive filler component, and an optional polysiloxane.

### BACKGROUND

There are known intermediate transfer members that include a liquid fluoro agent, however, this agent is incompatible with polymers like polyimides obtained from polyamic acid solutions, thus causing an unwanted phase separation of the polyimides.

A disadvantage relating to the preparation of an intermediate transfer member is that there is usually deposited a separate release layer on a metal substrate, and thereafter there is applied to the release layer the intermediate transfer member components, and where the release layer allows the components to be separated from the member by peeling or by the use of mechanical devices. Thereafter, the intermediate transfer member components in the form of a film can be selected for xerographic imaging systems, or where the film can be deposited on a supporting substrate like a polymer layer. The use of a separate intermediate release layer adds to the cost and to the time of preparation of intermediate transfer members, and such a layer can also modify a number of the intermediate transfer member characteristics.

There are known intermediate transfer members that include materials with characteristics that cause these members to become brittle resulting in inadequate acceptance of the developed image, and subsequent partial transfer of developed xerographic images to a substrate like paper.

There is a need for intermediate transfer members that substantially avoid or minimize the disadvantages of a number of known intermediate transfer members.

Further, there is a need for single layered intermediate transfer member materials with excellent and minimal curing times, and where there are avoided imidization reactions that can alter the properties of the member and also can result in added costs.

Also, there is a need for oleophobic intermediate transfer member materials that possess self release characteristics from a number of substrates that are selected when such members are prepared, and that exhibit a high Young's modulus of, for example, from about 5,000 to about 10,000 Mega Pascals (MPa), and an excellent break strength of, for example, from about 105 to about 300 MPa, or from about 150 to about 250 MPa.

Moreover, there is a need for intermediate transfer members which possess improved stability with no or minimal degradation for extended time periods.

Another need relates to intermediate transfer members that have excellent conductivity or resistivity leading to developed images with minimal resolution issues.

Additionally, there is a need for intermediate transfer member containing components that can be economically and efficiently manufactured.

Yet another need resides in providing intermediate transfer members where separate release additives need not be physically incorporated into the coating composition mixture selected in that such incorporation tends to form unwanted residues on metal substrates subsequent to eventual release of the composition.

Further, there is a need for intermediate transfer members with excellent resistivity, acceptable mechanical properties inclusive of extended time period toughness, stable substantially consistent characteristics, and low surface energy properties as determined, for example, by the water contact angles illustrated herein.

These and other needs are achievable in embodiments with the intermediate transfer members and components thereof disclosed herein.

### SUMMARY

There is disclosed an intermediate transfer member comprising a fluorinated polyamideimide and an optional conductive component.

Also, there is disclosed an oleophobic intermediate transfer member comprising a fluorinated polyamideimide, a conductive component, and an optional polysiloxane, wherein the fluorinated polyamideimide is selected from the group consisting of a fluorinated polyamideimide of trimellitic anhydride, methylene diphenyl diisocyanate and dodecafluorosuberic acid; a fluorinated polyamideimide of trimellitic anhydride, methylene diphenyl diisocyanate and hexadecafluorosebacic acid; a fluorinated polyamideimide of trimellitic anhydride, methylene diphenyl diisocyanate and octafluoroadipic acid; a fluorinated polyamideimide of trimellitic anhydride, tolylene-2,4-diisocyanate and dodecafluorosuberic acid; a fluorinated polyamideimide of trimellitic anhydride, tolylene-2,4-diisocyanate and hexadecafluorosebacic acid; a fluorinated polyamideimide of trimellitic anhydride, tolylene-2,4-diisocyanate and octafluoroadipic acid; a fluorinated polyamideimide of trimellitic anhydride, 3,3′-dimethyl-4,4′-biphenylene diisocyanate and dodecafluorosuberic acid; a fluorinated polyamideimide of trimellitic anhydride, 3,3′-dimethyl-4,4′-biphenylene diisocyanate and hexadecafluorosebacic acid; a fluorinated polyamideimide of trimellitic anhydride, 3,3′-dimethyl-4,4′-biphenylene diisocyanate and octafluoroadipic acid, and mixtures thereof.

Additionally, there is disclosed an intermediate transfer member comprised of a fluorinated polyamideimide and a conductive filler component, wherein said fluorinated polyamideamide is generated by the reaction of a trimellitic anhydride, an isocyanate selected from the group consisting of a monoisocyanate, a diisocyanate, and a polyisocyanate, and a fluoro dicarboxylic acid, and which member has a hexadecane contact angle of from about 30 to about 70 degrees.

Yet further, there is disclosed a fluorinated polyamideimide generated from the reaction of a trimellitic anhydride, an isocyanate, and an acid functionalized fluoro component.

### FIGURES

The following Figures are provided to further illustrate the intermediate transfer members disclosed herein.

FIG. 1 illustrates an exemplary embodiment of a one-layer intermediate transfer member of the present disclosure.

FIG. 2 illustrates an exemplary embodiment of a two-layer intermediate transfer member of the present disclosure.

FIG. 3 illustrates an exemplary embodiment of a three-layer intermediate transfer member of the present disclosure.

### EMBODIMENTS

There is disclosed herein an intermediate transfer member comprising a fluorinated polyamideimide and mixtures or blends thereof with suitable optional polymers, such as polysiloxanes and fluoropolymers, and a conductive filler component.

The fluorinated polyamideimide enables or assists in enabling self release of an intermediate transfer member film from a substrate like a metal substrate, such as stainless steel, thereby avoiding the need for a separate costly release layer on the substrate.

More specifically, there is provided herein an intermediate transfer member comprising an oleophobic mixture, in the configuration of a layer, of the disclosed fluorinated polyamideimide. Oleophobic mixture refers, for example, to a lack of affinity for oil thus protecting the member from individual hands and fingers, and allowing its reuse, and the other advantages illustrated herein.

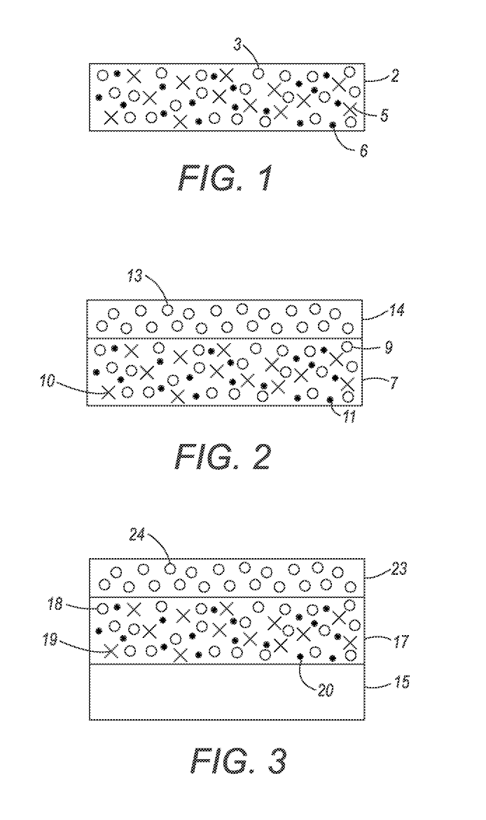

In FIG. 1 there is illustrated an intermediate transfer member comprising a layer 2 of a fluorinated polyamideimide 3, an optional siloxane polymer 5, and an optional conductive component 6.

In FIG. 2 there is illustrated a two-layer intermediate transfer member comprising a bottom layer 7 of a fluorinated polyamideimide 9, an optional siloxane polymer 10, and a conductive component 11, and an optional top or outer toner release layer 14 comprising film releasing components 13.

In FIG. 3 there is illustrated a three layer intermediate transfer member comprising a supporting substrate 15, a layer 17 of a fluorinated polyamideimide 18, an optional siloxane polymer 19, and an optional conductive component 20, and an optional release layer 23 comprising film releasing components 24.

The intermediate transfer members disclosed herein are oleophobic in that they exhibit excellent toner transfer and excellent cleaning efficiencies, and these members also exhibit self release characteristics, and where the use of an external release layer present on, for example, a stainless steel substrate is avoided; have excellent mechanical strength while permitting the rapid and complete transfer of from about 90 to about 99 percent, and from about 95 to about 100 percent transfer of a xerographic developed image from a photoconductor in a xerographic imaging process and xerographic apparatus; possess a Young's modulus of, for example, from about 5,000 to about 10,000 Mega Pascals (MPa), from about 5,500 to about 9,500, from about 6,000 to about 9,000 or from about 7,500 to about 8,700 MPa; a break strength of from about 100 to about 300 MPa, or from about 155 to about 215 MPa; a CTE (coefficient of thermal expansion) of from about 10 to about 50 ppm/° K, or from about 15 to about 30 ppm/° K; a hexadecane contact angle of from about 30 to about 70 degrees, from about 45 to about 55 degrees, or from about 50 degrees, and desirable resistivity as measured with a known High Resistivity Meter of, for example, from about 10⁸ to about 10¹³ ohm/square, from about 10⁹ to about 10¹³ ohm/square, from about 10⁹ to about 10¹² ohm/square, or from about 10⁹ to about 10¹⁰ ohm/square.

Self-release characteristics without the assistance of any external sources, such as prying devices, permits the efficient, economical formation, and full separation, from about 90 to about 100 percent, or from about 95 to about 99 percent of the disclosed intermediate transfer member films from metal substrates, and where release materials and separate release layers can be avoided. The time period to obtain the self-release characteristics of the disclosed intermediate transfer layer films varies depending, for example, on the components present and the amounts thereof selected for the fluorinated polyamideimide polymer layer. Generally, however, the release time period is from about 1 to about 60 seconds, from about 1 to about 45 seconds, from about 1 to about 30 seconds, from about 1 to about 20 seconds, or from 1 to about 5 seconds, and in some instances less than about 1 second.

The intermediate transfer members of the present disclosure can be provided in any of a variety of configurations, such as a one-layer configuration, or in a multi-layer configuration including, for example, a top release layer. More specifically, the final intermediate transfer member may be in the form of an endless flexible belt, a web, a flexible drum or roller, a rigid roller or cylinder, a sheet, a drelt (a cross between a drum and a belt), a seamless belt that is with an absence of any seams or visible joints in the members, and the like.

Fluorinated Polyamideimides

The disclosed novel fluorinated polyamideimides, the complex structures thereof which may perhaps be determined by a number of known techniques, such as NMR, can be prepared by the polymerization reaction, optionally in a solvent, of a trimellitic anhydride, an isocyanate, a diisocyanate, and an acid functionalized fluoro component such as a fluoro dicarboxylic acid.

Examples of Isocyanates

Isocyanates that can be used for the synthesis of the disclosed fluorinated polyamideimides include monoisocyanates, diisocyanates, polyisocyanates, and the like. Examples of the diisocyanates selected for the reactions illustrated herein include methylene diphenyl diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, tolylene-2,5-diisocyanate, tolylene-2,6-diisocyanate, trans-1,4-cyclohexylene diisocyanate, 3,3′-dimethoxy-4,4′-biphenylene diisocyanate, tolylene 2,4-diisocyanate terminated poly(propylene glycol), 2,4,6-trimethyl-1,3-phenylene diisocyanate, 4-chloro-6-methyl-1,3-phenylene diisocyanate, tolylene 2,4-diisocyanate terminated poly(1,4-butanediol), tetramethylene diisocyanate, octamethylene diisocyanate, α,α,α′,α′-tetramethyl-1,3-xylylene diisocyanate, 3,3′-dimethyldiphenylmethane-4,4′-diisocyanate, 3,3′-dimethyl-4,4′-biphenylene diisocyanate, other suitable know diisocyanates, mixtures thereof, and the like. Monoisocyanate examples selected for the disclosed reactions are those cyanates corresponding to the diisocyanates referenced herein, such as phenyl isocyanate, benzyl isocyanate, hexyl isocyanate, cyclohexyl isocyanate, p-tolyl isocyanate, and mixtures thereof. Polyisocyanate examples include polymers corresponding to the disclosed monoisocyanates and diisocyanates, like DESMODUR polyisocyanates available from Bayer, such as N75BA, N3390BA, and mixtures thereof.

Examples of Acid Functionalized Fluoro Components

The acid functionalized fluoro components utilized for the reactions disclosed herein can be represented by

HOOC(CF₂)ₙCOOH

wherein n represents the number of repeating groups of, for example, from about 1 to about 20, from about 2 to about 18, from about 2 to about 12, from about 2 to about 10, from about 4 to about 10, or from about 2 to about 5
or

CₙF₂ₙ₊₁COOH

wherein n represents the number of atoms, and more specifically, where n is, for example, a number of from about 1 to about 18, from about 2 to about 18, from about 2 to about 12, from about 2 to about 10, from about 4 to about 10, or from about 2 to about 5.

Specific examples of carboxylic acid functionalized fluoro components selected for the reactions disclosed herein are octafluoroadipic acid HOOC(CF₂)₄COOH, dodecafluorosuberic acid HOOC(CF₂)₆COOH, hexadecafluorosebacic acid HOOC(CF₂)₈COOH, heptadecafluoro-n-nonanoic acid CF₃(CF₂)₇COOH, nonadecafluorodecanoic acid CF₃(CF₂)₈COOH, nonafluorovaleric acid CF₃(CF₂)₃COOH, pentadecafluorooctanoic acid CF₃(CF₂)₆COOH, undecafluorohexanoic acid CF₃(CF₂)₄COOH, mixtures thereof, and the like.

Fluorinated Polyamideimides

Examples of the fluorinated polyamideimides obtained in accordance with the disclosed reactions include a fluorinated polyamideimide of trimellitic anhydride, methylene diphenyl diisocyanate and dodecafluorosuberic acid; a fluorinated polyamideimide of trimellitic anhydride, methylene diphenyl diisocyanate and hexadecafluorosebacic acid; a fluorinated polyamideimide of trimellitic anhydride, methylene diphenyl diisocyanate, and octafluoroadipic acid; a fluorinated polyamideimide of trimellitic anhydride, tolylene-2,4-diisocyanate and dodecafluorosuberic acid; a fluorinated polyamideimide of trimellitic anhydride, tolylene-2,4-diisocyanate and hexadecafluorosebacic acid; a fluorinated polyamideimide of trimellitic anhydride, tolylene-2,4-diisocyanate and octafluoroadipic acid; a fluorinated polyamideimide of trimellitic anhydride, 3,3′-dimethyl-4,4′-biphenylene diisocyanate and dodecafluorosuberic acid; a fluorinated polyamideimide of trimellitic anhydride, 3,3′-dimethyl-4,4′-biphenylene diisocyanate and hexadecafluorosebacic acid; a fluorinated polyamideimide of trimellitic anhydride, 3,3′-dimethyl-4,4′-biphenylene diisocyanate and octafluoroadipic acid, mixtures thereof, and the like.

The fluorinated polyamideimide has, for example, a number average molecular weight of from about 3,000 to about 20,000, from about 4,000 to about 16,000, or from about 7,000 to about 12,000; a weight average molecular weight of, for example, from about 5,000 to about 30,000, from about 6,000 to about 20,000, from about 7,000 to about 30,000, or from about 9,000 to about 15,000, and a fluorine content of, for example, from about 2 to about 40 weight percent, from about 5 to about 25 weight percent, or from about 8 to about 15 weight percent based on the polyamideimide polymer. The fluorine content of the fluorinated polyamideimide can be determined or estimated from, for example, the initial feed amounts of the reactants of the trimellitic anhydride, the isocyanate and the acid functionalized fluoro component, and as evidenced by the hexadecane contact angles and changes thereof.

Reaction Parameters

A trimellitic anhydride of from about 20 to about 40 weight percent, or from about 25 to about 35 weight percent of the total reactant solids, and an acid functionalized fluoro component of from about 5 to about 40 weight percent, or from about 15 to about 25 weight percent of the total reactant solids are dissolved in a suitable solvent, such as N-methyl-2-pyrrolidone (NMP), N,N-dimethylformamide (DMF), N,N-dimethylacetamide (DMAc), dimethylsulfoxide (DMSO), and the like, with the reactant solid contents being from about 10 to about 30, or from 15 to about 25 weight percent. Subsequently, to the obtained mixture and with mechanical stirring under argon or a nitrogen gas flow, there can be added an isocyanate in an amount of, for example, from about 30 to about 75 weight percent, or from about 40 to about 60 weight percent of the total reactant solids. The resulting mixture can then be slowly heated to temperatures of from about 70° C. to about 90° C., or from about 75° C. to about 85° C. of, for example, time of from about 1 to about 4 hours, or from about 2 to about 3 hours, and retained at these temperatures for an additional from about 1 to about 4 hours, or from about 2 to about 3 hours. Thereafter, the obtained reaction solution can be heated to, for example, temperatures of from about 130° C. to about 180° C., or from about 150° C. to about 170° C. for a time period of, for example, from about 1 to about 8 hours or from about 3 to about 6 hours. After cooling the aforementioned obtained solution to room temperature of from about 23° C. to about 25° C., a viscous brownish fluorinated polyamideimide solution can be generated.

Polysiloxane Polymers

The intermediate transfer member can also generally comprise suitable known binder polymers like a polysiloxane polymer. Examples of polysiloxane polymers selected for the intermediate transfer member mixture disclosed herein include known suitable polysiloxanes, such as a polyether modified polydimethylsiloxane, commercially available from BYK Chemical as BYK® 333, BYK® 330 (about 51 weight percent in methoxypropylacetate), BYK® 344 (about 52.3 weight percent in xylene/isobutanol, ratio of 80/20), BYK®-SILCLEAN 3710 and BYK® 3720 (about 25 weight percent in methoxypropanol); a polyester modified polydimethylsiloxane, commercially available from BYK Chemical as BYK® 310 (about 25 weight percent in xylene) and BYK® 370 (about 25 weight percent in xylene/alkylbenzenes/cyclohexanone/monophenylglycol, ratio of 75/11/7/7); a polyacrylate modified polydimethylsiloxane, commercially available from BYK Chemical as BYK®-SILCLEAN 3700 (about 25 weight percent in methoxypropylacetate); a polyester polyether modified polydimethylsiloxane, commercially available from BYK Chemical as BYK® 375 (about 25 weight percent in di-propylene glycol monomethyl ether), and mixtures thereof.

The polysiloxane polymer or copolymers thereof can be present in the intermediate transfer member mixture in various effective amounts, such as from about 0.01 to about 1 weight percent, from about 0.05 to about 1 weight percent, from about 0.05 to about 0.5 weight percent, or from about 0.1 to about 0.3 weight percent based on the weight of the solid components present in the mixture, such as the components of the synthesized fluorinated polyamideimide, the optional polysiloxane polymer, and when present the conductive component.

Optional Fillers

Optionally, the intermediate transfer member may contain one or more component fillers to, for example, alter and adjust the conductivity of the intermediate transfer member. Where the intermediate transfer member is a one layer structure, the conductive filler can be included in the fluorinated polyamideimide disclosed herein. However, when the intermediate transfer member is a multi-layer structure, the conductive filler can be included in one or more layers of the member, such as in the supporting substrate, the fluorinated polyamideimide polymer or mixture layer coated thereon, and in both the supporting substrate and the fluorinated polyamideimide polymer mixture layer.

Various effective suitable filler can be used that provide the desired results. For example, suitable fillers include carbon blacks, metal oxides, polyanilines, other known suitable fillers, and mixtures of fillers.

Examples of carbon black fillers that can be selected for the intermediate transfer members illustrated herein include special black 4 (B.E.T. surface area=180 m²/g, DBP absorption=1.8 ml/g, primary particle diameter=25 nanometers) available from Evonik-Degussa, special black 5 (B.E.T. surface area=240 m²/g, DBP absorption=1.41 ml/g, primary particle diameter=20 nanometers), color black FW1 (B.E.T. surface area=320 m²/g, DBP absorption=2.89 ml/g, primary particle diameter=13 nanometers), color black FW2 (B.E.T. surface area=460 m²/g, DBP absorption=4.82 ml/g, primary particle diameter=13 nanometers), color black FW200 (B.E.T. surface area=460 m²/g, DBP absorption=4.6 ml/g, primary particle diameter=13 nanometers), all available from Evonik-Degussa; VULCAN® carbon blacks, REGAL® carbon blacks, MONARCH® carbon blacks and BLACK PEARLS® carbon blacks available from Cabot Corporation. Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); special carbon blacks available from Evonik Incorporated; and Channel carbon blacks available from Evonik-Degussa. Other known suitable carbon blacks not specifically disclosed herein may be selected as the filler or conductive component for the intermediate transfer members disclosed herein.

Examples of polyaniline fillers that can be selected for incorporation into the intermediate transfer member compositions are PANIPOL™ F, commercially available from Panipol Oy, Finland and known lignosulfonic acid grafted polyanilines. These polyanilines usually have a relatively small particle size diameter of, for example, from about 0.5 to about 5 microns; from about 1.1 to about 2.3 microns, or from about 1.5 to about 1.9 microns.

Metal oxide fillers that can be selected for the disclosed intermediate transfer member composition include, for example, tin oxide, antimony doped tin oxide, indium oxide, indium tin oxide, zinc oxide, and titanium oxide, and the like.

When present, the filler can be selected in an amount of, for example, from about 1 to about 60 weight percent, from about 3 to about 40 weight percent, from about 4 to about 30 weight percent, from about 10 to about 30 percent, from about 3 to about 30 weight percent, from about 5 to about 30 weight percent, from about 8 to about 25 weight percent, or from about 13 to about 20 weight percent of the total solids of the synthesized fluorinated polyamideimide, and the conductive component or filler. The ratio weight of the polyamideimide to the conductive component, such as carbon black, is, for example, from about 95/5 to about 60/40 or from about 90/10 to about 80/20.

Optional Release Layer

When desired, an optional release layer can be included over the fluorinated polyamideimide layer illustrated herein. The release layer may be included to assist in providing additional toner cleaning, and further developed image transfer efficiency from a photoconductor to the intermediate transfer member.

When selected, the release layer can have any desired and suitable thickness. For example, the release layer can have a thickness of from about 1 to about 100 microns, about 10 to about 75 microns, or from about 20 to about 50 microns.

The optional release layer can comprise TEFLON®-like materials including fluorinated ethylene propylene copolymer (FEP), polytetrafluoroethylene (PTFE), polyfluoroalkoxy polytetrafluoroethylene (PFA TEFLON®), and other TEFLON®-like materials; silicone materials, such as fluorosilicones and silicone rubbers, such as Silicone Rubber 552, available from Sampson Coatings, Richmond, Va., (polydimethyl siloxane/dibutyl tin diacetate, 0.45 gram DBTDA per 100 grams of the polydimethyl siloxane rubber mixture with a molecular weight M_{w} of approximately 3,500); and fluoroelastomers, such as those sold as VITON®, such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, and VITON GF®. The VITON® designation is a Trademark of E.I. DuPont de Nemours, Inc. Two known fluoroelastomers are comprised of (1) a class of copolymers of vinylidenefluoride, hexafluoropropylene, and tetrafluoroethylene, known commercially as VITON A®; (2) a class of terpolymers of vinylidenefluoride, hexafluoropropylene, and tetrafluoroethylene, known commercially as VITON B®; and (3) a class of tetrapolymers of vinylidenefluoride, hexafluoropropylene, tetrafluoroethylene, and a cure site monomer, such as VITON GF®, having 35 mole percent of vinylidenefluoride, 34 mole percent of hexafluoropropylene, and 29 mole percent of tetrafluoroethylene with 2 percent cure site monomer. The cure site monomers can be those available from E.I. DuPont de Nemours, Inc. such as 4-bromoperfluorobutene-1,1,1-dihydro-4-bromoperfluorobutene-1,3-bromoperfluoropropene-1,1,1-dihydro-3-bromoperfluoropropene-1, or commercially available cure site monomers.

Intermediate Transfer Member Formation

The intermediate transfer member fluorinated polyamideimide or mixtures thereof illustrated herein comprising, for example, the generated fluorinated polyamideimide and a conductive filler component can be formulated into an intermediate transfer member by any suitable method. For example, with known milling processes, the fluorinated polyamideimide or uniform dispersions of the fluorinated polyamideimide intermediate transfer member mixtures can be obtained, heated and cured at from about 100° C. to about 400° C., from about 200° C. to about 350° C., from about 275° C. to about 320° C., from about 120° C. to about 190° C. or from about 160° C. to about 290° C. for a suitable period of time of, for example, from about 30 to 180 minutes, from about 45 minutes to about 120 minutes, or from about 30 to about 90 minutes, and then coated on individual metal substrates, such as a stainless steel substrate, or the like, using known draw bar coating or flow coating methods. The resulting individual film or films can be dried at high temperatures, such as by heating and curing the films as illustrated herein, such as by heating at 120° C. for 30 minutes, 190° C. for 30 minutes, and 320° C. for 60 minutes, or generally curing by heating the intermediate transfer member mixture to from about 100° C. to about 400° C. while remaining on the substrate. After drying and cooling to room temperature, about 23° C. to about 25° C., the films self release from the steel substrates, that is the film release without any external assistance. The resultant intermediate transfer film product can have a thickness of, for example, from about 15 to about 150 microns, from about 20 to about 100 microns, or from about 50 to about 75 microns.

As metal substrates selected for the deposition of the fluorinated polyamideimide or the fluorinated polyamideimide mixture disclosed herein, there can be selected stainless steel, aluminum, nickel, copper, and their alloys, glass plates, and other conventional typical known materials.

Examples of solvents selected for formation of the intermediate transfer member mixture compositions, which solvents can be selected in an amount of, for example, from about 60 to about 95 weight percent, or from about 70 to about 90 weight percent of the total mixture components include alkylene halides, such as methylene chloride, tetrahydrofuran, toluene, halobenzenes, such as monochlorobenzene; N-methyl-2-pyrrolidone, N,N-dimethylformamide, N,N-dimethylacetamide, methyl ethyl ketone, dimethylsulfoxide, methyl isobutyl ketone, formamide, acetone, ethyl acetate, cyclohexanone, acetanilide, mixtures thereof, and the like. Diluents can be mixed with the solvents selected for the intermediate transfer member mixtures. Examples of diluents added to the solvents in amounts of from about 1 to about 25 weight percent, and from 1 to about 10 weight percent based on the weight of the solvent and the diluent are known diluents like aromatic hydrocarbons, ethyl acetate, acetone, cyclohexanone, and acetanilide.

Optional Supporting Substrates

An optional supporting substrate can be included in the intermediate transfer member, such as beneath the generated fluorinated polyamideimide containing layer. An optional supporting substrate can be included to provide increased rigidity or strength to the intermediate transfer member.

Examples of the intermediate transfer member supporting substrates are polyimides inclusive of known low temperature, and rapidly cured polyimide polymers, such as VTEC™ PI 1388, 080-051, 851, 302, 203, 201, and PETI-5, all available from Richard Blaine International, Incorporated, Reading, Pa., polyamideimides, polyetherimides, and the like. The thermosetting polyimides can be cured at temperatures of from about 180° C. to about 260° C. over a short period of time, such as from about 10 to about 120 minutes, or from about 20 to about 60 minutes, and generally have a number average molecular weight of from about 5,000 to about 500,000 or from about 10,000 to about 100,000, and a weight average molecular weight of from about 50,000 to about 5,000,000 or from about 100,000 to about 1,000,000. Also, for the supporting substrate there can be selected thermosetting polyimides that can be cured at temperatures of above 300° C., such as PYRE M.L.® RC-5019, RC 5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Examples of polyamideimides that can be selected as supporting substrates for the intermediate transfer members disclosed herein are VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15, T_{g}=255° C., and M_{w}=8,000), HR-13NX (30 weight percent solution in N-methylpyrrolidone/xylene=67/33, T_{g}=280° C., and M_{w}=10,000), HR-15ET (25 weight percent solution in ethanol/toluene=50/50, T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON® AI-10 (T_{g}=272° C.), commercially available from Solvay Advanced Polymers, LLC, Alpharetta, Ga.

Examples of specific polyetherimide supporting substrates that can be selected for the intermediate transfer members disclosed herein are ULTEM® 1000 (T_{g}=210° C.), 1010 (T_{g}=217° C.), 1100 (T_{g}=217° C.), 1285, 2100 (T_{g}=217° C.), 2200 (T_{g}=217° C.), 2210 (T_{g}=217° C.), 2212 (T_{g}=217° C.), 2300 (T_{g}=217° C.), 2310 (T_{g}=217° C.), 2312 (T_{g}=217° C.), 2313 (T_{g}=217° C.), 2400 (T_{g}=217° C.), 2410 (T_{g}=217° C.), 3451 (T_{g}=217° C.), 3452 (T_{g}=217° C.), 4000 (T_{g}=217° C.), 4001 (T_{g}=217° C.), 4002 (T_{g}=217° C.), 4211 (T_{g}=217° C.), 8015, 9011 (T_{g}=217° C.), 9075, and 9076, all commercially available from Sabic Innovative Plastics.

Once formed, the supporting substrate can have any desired and suitable thickness. For example, the supporting substrate can have a thickness of from about 10 to about 300 microns, such as from about 50 to about 150 microns, from about 75 to about 125 microns, or about 80 microns.

The intermediate transfer members illustrated herein can be utilized for a number of printing and copying systems, inclusive of xerographic printing systems that contain photoconductors. For example, the disclosed intermediate transfer members can be incorporated into a multi-imaging xerographic machine where each developed toner image to be transferred is formed on a photoconductor at an image forming station, and where each of these images is then developed at a developing station, and transferred to the intermediate transfer member. Also, the images may be formed on a photoconductor and developed sequentially, and then transferred to the intermediate transfer member. In an alternative method, each image may be formed on the photoconductor or photoreceptor drum, developed, and then transferred in registration to the intermediate transfer member. The multi-image stage system in embodiments can be a color copying system, wherein each color of an image being copied is formed on a photoconductor, developed with toners, and transferred to the intermediate transfer member.

After the toner latent image has been transferred from the photoreceptor drum to the intermediate transfer member, the intermediate transfer member may be contacted under heat and pressure with an image receiving substrate such as paper. The toner image on the intermediate transfer member is then transferred and fixed by heat in image configuration to an image receiving substrate.

Specific embodiments will now be described in detail. These examples are intended to be illustrative, and are not limited to the materials, conditions, or process parameters set forth in these embodiments. All parts are percentages by weight of total solids of all the components unless otherwise indicated.

### Comparative Example 1

A polyimide coating composition was prepared by stirring a mixture of special carbon black 4 obtained from Evonik Incorporated, and a polyamic acid of biphenyl tetracarboxylic dianhydride/4,4′-oxydianiline U-VARNISH S available from UBE America Inc., New York, N.Y., in a weight ratio of 13/87 based on the initial mixture feed amounts, in N-methyl-2-pyrrolidone (NMP), about 16 weight solids. The obtained intermediate transfer member dispersion was coated on a stainless steel substrate of a thickness of 0.5 millimeter, and subsequently the mixture was cured by heating at 125° C. for 30 minutes, 190° C. for 30 minutes, and 320° C. for 60 minutes. The resulting intermediate transfer member film comprised of the above components in the ratios indicated did not self release from the stainless substrate, but rather adhered to this substrate. Only after being immersed in water for 3 months, the intermediate transfer member film obtained eventually self released from the substrate.

### Example I

Trimellitic anhydride (15 grams) and dodecafluorosuberic acid [HOOC(CF₂)₆COOH] (5 grams) were dissolved in the solvent N-methyl-2-pyrrolidone (NMP) (200 milliliters). Subsequently, there was added to the resulting solution, with mechanical stirring and under an argon gas flow, methylene diphenyl diisocyanate (25 grams). The resulting mixture was slowly heated to 80° C. over a 2 hour period, and retained at this temperature for 1.5 hours. Thereafter, the obtained reaction solution was heated to 145° C. for 2 hours. After cooling down to room temperature, about 25° C., a viscous brownish fluorinated polyamideimide containing solution was obtained.

Carbon black (special black 4 as obtained from Evonik Incorporated) was then incorporated into the above prepared fluorinated polyamideimide solution via ball milling, resulting in an intermediate transfer member dispersion comprising the fluorinated polyamideimide/carbon black, 87/13, in N-methyl-2-pyrrolidone (NMP) about 20 weight percent solids. This dispersion was then coated by a known drawn bar coater on a stainless steel substrate, and cured at 120° C. for 30 minutes, 190° C. for 30 minutes, and 320° C. for 60 minutes. After cooling to room temperature of about 25° C., the resulting fluorinated polyamideimide intermediate transfer member film immediately self released, less than one second, from the stainless steel without the assistance of any external processes. There resulted a 75 micron thick smooth film of the above components in an 87/13 weight ratio of the fluorinated polyamideimide/carbon black.

The above generated fluorinated polyamideimide with a number average molecular weight of about 7,000 and a weight average molecular weight of about 15,000, both as determined by GPC analysis, was a fluorinated polyamideimide of trimellitic anhydride, methylene diphenyl diisocyanate, and dodecafluorosuberic acid.

### Example II

An intermediate transfer member is prepared by repeating the processes of Example I except that there is selected in place of dodecafluorosuberic acid, hexadecafluorosebacic acid or octafluoroadipic acid, and substantially similar products and similar results are believed to be obtainable.

### Example III

An intermediate transfer member is prepared by repeating the processes of Example I except there is selected in place of the methylene diphenyl diisocyanate, 3,3′-dimethyl-4,4′-biphenylene diisocyanate or tolylene-2,4-diisocyanate, and substantially similar products, and similar results are believed to be obtainable.

### Measurements

The resistivity of the above Example I and Comparative Example 1 intermediate transfer member films were measured using a High Resistivity Meter.

The above intermediate transfer members of Example I and Comparative Example 1 were also measured for Young's Modulus following the known ASTM D882-97 process. Samples (0.5 inch×12 inch) of each intermediate transfer member were placed in the Instron Tensile Tester measurement apparatus, and then the samples were elongated at a constant pull rate until breaking. During this time, there was recorded the resulting load versus the sample elongation. The Young's Modulus was calculated by taking any point tangential to the initial linear portion of the recorded curve results and dividing the tensile stress by the corresponding strain. The tensile stress was calculated by the load divided by the average cross sectional area of each of the test samples. Break strength was measured by the tensile stress when the sample broke.

The intermediate transfer members of Example I and Comparative Example 1 were further tested for their thermal expansion coefficients (CTE) using a Thermo-mechanical Analyzer (TMA). The intermediate transfer member samples were cut using a razor blade and a metal die to 4 millimeter wide pieces which were then mounted between the TMA clamp using a measured 8 millimeter spacing. The samples were preloaded to a force of 0.05 Newton (N). Data was analyzed from the 2^{nd} heat cycle. The CTE value was obtained as a linear fit through the data between the temperature points of interest of from about a −20° C. to about 50° C. regions using the TMA software.

The hexadecane contact angle, which can be used to assist in determining the fluoro content, and also this angle translates into the degree of oleophobic characteristics and surface energy, was at ambient temperature (about 23° C.) measured by using the Contact Angle System OCA (Dataphysics Instruments GmbH, model OCA15). At least ten measurements were performed, and their averages were recorded. The oleophobic Example I member had an average measured hexadecane contact angle of about 40 degrees higher than that of the Comparative Example 1 member of about 10 degrees.

The data obtained per the above measurements are shown in Table 1.

TABLE 1

| | Surface | Young's | Break | Hexadecane | |
|---|---|---|---|---|---|
| | Resistivity | Modulus | Strength | Contact | CTE |
| | (ohm/sq) | (MPa) | (MPa) | Angle | (ppm/° K) |
| Example I | 5.1 × 10⁹ | 8,700 | 210 | 50 degrees | 18.4 |
| Comparative | 2.4 × 10¹⁰ | 6,000 | 163 | 10 degrees | 38.4 |
| Example 1 | | | | | |

The mechanical properties of the disclosed fluorinated polyamideimide intermediate transfer member (Example I) were superior to a conventional polyimide intermediate transfer member (Comparative Example 1) with an about 45 percent higher Young's modulus, about a 29 percent higher break strength, and an about 48 percent lower CTE.

Furthermore, the disclosed fluorinated polyamideimide intermediate transfer member of Example I was more oleophobic, as demonstrated by the higher hexadecane contact angle of 50 degrees, than that of the conventional polyimide intermediate transfer member of Comparative Example 1, which higher contact angle improves the toner transfer efficiency and the cleaning of the photoconductor.

Also, the intermediate transfer member of Example I self released quickly, less than one second, from the stainless substrate without the need to apply an additional release layer on the stainless steel, while the Comparative Example 1 member did not self release and remained on the stainless steel substrate, being released only after immersed in water for three months.

The Example I intermediate transfer member was obtained at a lower cost, about 55 percent lower, than a number of known intermediate transfer members that were free of a fluorinated polyamideimide in that the Example I member does not require an added release layer coating on a stainless steel substrate when the member is initially prepared.

After being released from the stainless steel substrate, the Example I intermediate transfer film obtained can be used as an intermediate transfer member, can be coated on a supporting substrate, or an optional release layer can be coated on top of the Example I intermediate transfer layer film.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. An intermediate transfer member comprising a fluorinated polyamideimide and an optional conductive component.

2. An intermediate transfer member in accordance with claim 1 wherein said fluorinated polyamideimide is generated by the reaction of a trimellitic anhydride, an isocyanate, and an acid functionalized fluoro component.

3. An intermediate transfer member in accordance with claim 2 wherein said isocyanate is a monoisocyanate, a diisocyanate, or a polyisocyanate, and said acid functionalized fluoro component is a fluoro carboxylic acid.

4. An intermediate transfer member in accordance with claim 3 wherein said isocyanate is a diisocyanate selected from a group of methylene diphenyl diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, tolylene-2,5-diisocyanate, tolylene-2,6-diisocyanate, trans-1,4-cyclohexylene diisocyanate, 3,3′-dimethoxy-4,4′-biphenylene diisocyanate, tolylene 2,4-diisocyanate terminated poly(propylene glycol), 2,4,6-trimethyl-1,3-phenylene diisocyanate, 4-chloro-6-methyl-1,3-phenylene diisocyanate, tolylene 2,4-diisocyanate terminated poly(1,4-butanediol), tetramethylene diisocyanate, octamethylene diisocyanate, α,α,α′,α′-tetramethyl-1,3-xylylene diisocyanate, 3,3′-dimethyldiphenylmethane-4,4′-diisocyanate, 3,3′-dimethyl-4,4′-biphenylene diisocyanate, and mixtures thereof, and said fluoro carboxylic acid is represented by
HOOC(CF₂)ₙCOOH
wherein n represents the number of repeating segments of from about 1 to about 20,
or
CₙF₂ₙ₊₁COOH
wherein n represents the number of atoms of from about 1 to about 18.

5. An intermediate transfer member in accordance with claim 3 wherein said fluoro carboxylic acid is selected from the group consisting of octafluoroadipic acid HOOC(CF₂)₄COOH, dodecafluorosuberic acid HOOC(CF₂)₆COOH, hexadecafluorosebacic acid HOOC(CF₂)₈COOH, heptadecafluoro-n-nonanoic acid CF₃(CF₂)₇COOH, nonadecafluorodecanoic acid CF₃(CF₂)₈COOH, nonafluorovaleric acid CF₃(CF₂)₃COOH, pentadecafluorooctanoic acid CF₃(CF₂)₆COOH, undecafluorohexanoic acid CF₃(CF₂)₄COOH, and mixtures thereof.

6. An intermediate transfer member in accordance with claim 1 wherein said conductive component is present, and where the ratio of said fluorinated polyamideimide to said conductive component is from about 95/5 to about 60/40.

7. An intermediate transfer member in accordance with claim 1 wherein said conductive component is present, and the ratio of said fluorinated polyamideimide to said conductive component is from about 90/10 to about 80/20, and said fluorinated polyamideimide has a fluorine content of from about 2 to about 40 weight percent.

8. An intermediate transfer member in accordance with claim 2 wherein said trimellitic anhydride is selected in an amount of from about 20 to about 40 weight percent, said isocyanate is selected in an amount of from about 30 to about 75 weight percent, and said acid functionalized fluoro component is selected in an amount of from about 5 to about 40 weight percent based on the total of about 100 percent of solids present.

9. An intermediate transfer member in accordance with claim 2 wherein said fluorinated polyamideimide possesses a weight average molecular weight of from about 7,000 to about 30,000, and a number average molecular weight of from about 3,000 to about 20,000 as determined by Gel Permeation Chromatography, and wherein said conductive component is present.

10. An intermediate transfer member in accordance with claim 2 wherein said fluorinated polyamideimide is selected from the group consisting of a fluorinated polyamideimide of trimellitic anhydride, methylene diphenyl diisocyanate and dodecafluorosuberic acid; a fluorinated polyamideimide of trimellitic anhydride, methylene diphenyl diisocyanate and hexadecafluorosebacic acid; a fluorinated polyamideimide of trimellitic anhydride, methylene diphenyl diisocyanate and octafluoroadipic acid; a fluorinated polyamideimide of trimellitic anhydride, tolylene-2,4-diisocyanate and dodecafluorosuberic acid; a fluorinated polyamideimide of trimellitic anhydride, tolylene-2,4-diisocyanate and hexadecafluorosebacic acid; a fluorinated polyamideimide of trimellitic anhydride, tolylene-2,4-diisocyanate and octafluoroadipic acid; a fluorinated polyamideimide of trimellitic anhydride, 3,3′-dimethyl-4,4′-biphenylene diisocyanate and dodecafluorosuberic acid; a fluorinated polyamideimide of trimellitic anhydride, 3,3′-dimethyl-4,4′-biphenylene diisocyanate and hexadecafluorosebacic acid; and a fluorinated polyamideimide of trimellitic anhydride, 3,3′-dimethyl-4,4′-biphenylene diisocyanate and octafluoroadipic acid.

11. An intermediate transfer member in accordance with claim 2 wherein said fluorinated polyamideimide is selected from the group consisting of a fluorinated polyamideimide of trimellitic anhydride, methylene diphenyl diisocyanate and dodecafluorosuberic acid; a fluorinated polyamideimide of trimellitic anhydride, methylene diphenyl diisocyanate and hexadecafluorosebacic acid; and a fluorinated polyamideimide of trimellitic anhydride, methylene diphenyl diisocyanate and octafluoroadipic acid.

12. An intermediate transfer member in accordance with claim 2 wherein said conductive component is present and is comprised of carbon black present in an amount of from about 5 to about 30 weight percent based on the total of said ingredients in said member being about 100 percent.

13. An intermediate transfer member in accordance with claim 2 wherein said conductive component is present, and is comprised of a metal oxide, or a polyaniline.

14. An intermediate transfer member in accordance with claim 2 wherein the member has a fluorine content of from about 5 to about 25 weight percent, and a resistivity of from about 10⁹ to about 10¹² ohm/square.

15. An intermediate transfer member in accordance with claim 2 wherein said member is in the form of a belt and self releases from a metal substrate, and wherein said member has a hexadecane contact angle of from about 30 to about 70 degrees.

16. An oleophobic intermediate transfer member comprising a fluorinated polyamideimide, a conductive component, and an optional polysiloxane, wherein said fluorinated polyamideimide is selected from the group consisting of a fluorinated polyamideimide of trimellitic anhydride, methylene diphenyl diisocyanate and dodecafluorosuberic acid; a fluorinated polyamideimide of trimellitic anhydride, methylene diphenyl diisocyanate and hexadecafluorosebacic acid; a fluorinated polyamideimide of trimellitic anhydride, methylene diphenyl diisocyanate and octafluoroadipic acid; a fluorinated polyamideimide of trimellitic anhydride, tolylene-2,4-diisocyanate and dodecafluorosuberic acid; a fluorinated polyamideimide of trimellitic anhydride, tolylene-2,4-diisocyanate and hexadecafluorosebacic acid; a fluorinated polyamideimide of trimellitic anhydride, tolylene-2,4-diisocyanate and octafluoroadipic acid; a fluorinated polyamideimide of trimellitic anhydride, 3,3′-dimethyl-4,4′-biphenylene diisocyanate and dodecafluorosuberic acid; a fluorinated polyamideimide of trimellitic anhydride, 3,3′-dimethyl-4,4′-biphenylene diisocyanate and hexadecafluorosebacic acid; a fluorinated polyamideimide of trimellitic anhydride, 3,3′-dimethyl-4,4′-biphenylene diisocyanate and octafluoroadipic acid, and mixtures thereof.

17. An intermediate transfer member in accordance with claim 16 wherein said fluorinated polyamideimide is selected from the group consisting of a fluorinated polyamideimide of a trimellitic anhydride, methylene diphenyl diisocyanate and dodecafluorosuberic acid; a fluorinated polyamideimide of trimellitic anhydride, methylene diphenyl diisocyanate and hexadecafluorosebacic acid; and a fluorinated polyamideimide of trimellitic anhydride, methylene diphenyl diisocyanate and octafluoroadipic acid.

18. An intermediate transfer member in accordance with claim 16 wherein said fluorinated polyamideimide member possesses a coefficient of thermal expansion of from about 15 to about 30 ppm/° K.

19. An intermediate transfer member in accordance with claim 16 wherein said fluorinated polyamideimide member possesses a Young's Modulus of from about 5,500 to about 9,500 Mega Pascals.

20. An intermediate transfer member in accordance with claim 2 which member has a hexadecane contact angle of from about 30 to about 70 degrees.

21. A fluorinated polyamideimide generated from the reaction of a trimellitic anhydride, an isocyanate, and an acid functionalized fluoro component.
